(19) United States
(12) Patent Application Publication
(10) Pub. No.: US 2018/0080771 A1
(43) Pub. Date: Mar. 22, 2018

(54) SYSTEM, APPARATUS AND METHODOLOGY FOR FLIGHT OPERATION IMAGING

(71) Applicant: NOAA Technology Partnerships Office, Silver Spring, MD (US)

(72) Inventors: Jon Sellars, Rockville, MD (US); Jason Woolard, Fredericksburg, VA (US)

(73) Assignee: NOAA Technology Partnerships Office, Silver Spring, MD (US)

(21) Appl. No.: 15/713,467

(22) Filed: Sep. 22, 2017

Related U.S. Application Data
(60) Provisional application No. 62/398,010, filed on Sep. 22, 2016.

(51) Int. Cl. G01C 21/00; G08G 5/00; G06T 11/20; G06T 11/60

(52) U.S. Cl. CPC G01C 21/005; G08G 5/0039; G06F 3/04847; G06T 11/60; G06T 2200/24; G06T 11/203

(57) ABSTRACT

A system, apparatus and methodology for pilot navigation employing dynamic visual displays of geographical features along with dynamically-computed flight paths and dynamic visual feedback of image footprints, including better imaging of coastlines and other aerially-observed geographical features.

### CROSS REFERENCE TO RELATED APPLICATIONS

The present invention claims the benefit from U.S. Patent Application Ser. No. 62/398,010, entitled “SYSTEM, APPARATUS AND METHODOLOGY FOR FLIGHT OPERATION IMAGING,” filed Sep. 22, 2017, the subject matter of which is incorporated by reference herein.

### STATEMENT REGARDING FEDERAL RIGHTS

The invention described herein was made with support from the National Oceanic and Atmospheric Administration (NOAA) of the United States Department of Commerce. The United States Government has certain rights in the invention.

### FIELD OF THE INVENTION

The present disclosure relates generally to imaging systems, particularly terrain imaging systems for pilots.

### BACKGROUND OF THE INVENTION

Commercial, military and civilian pilots employ navigation systems and terrain imagers. All or most of the available imagers for flight use usually employ pre-computed or known flight paths. This use of predetermined flight paths, with no flexibility, has become the industry norm, despite various problems, such as the need to adjust flight paths in emergencies, and adapt to all terrain, such as along coastlines.

With the increased need for vigilance in Homeland Security and other high-priority or emergency uses, there is a present need for an adaptable, on-the-fly-type system and technique, whereby the requisite imaging can be attained for modified and modifiable flight paths. Since existing techniques have considerable trouble properly imaging coastlines, an improved imaging paradigm is needed to overcome this deficit, which would immediately help Coast Guard and other authorities.

For example, NOAA's National Geodetic Survey supports Homeland Security and emergency response geospatial requirements by acquiring and rapidly disseminating spatially-referenced remote sensing datasets. Through the collection of oblique imagery immediately following an event, the present invention can thus quickly provide situational awareness to emergency managers to assist in developing recovery strategies, to assess damage by comparing pre and post event imagery and to allow displaced residents to see images of their neighborhoods and homes, which is also valuable for coastal and flood prone regions where the terrain shifts.

Thus, there is a present need for systems and techniques that allow free-form navigation and on-the-fly mission planning, which is something unavailable in the systems, apparatuses and techniques of the prior art.

Additionally, since existing imaging techniques and equipment can be expensive and cumbersome to operate, there is a further need that the improved system, apparatus and methodology of the present invention be inexpensive and easy to employ and deploy, especially in emergency-type conditions.

Also, whereas existing techniques require an operator to start or initiate the program or method, the present invention allows for self-starting imaging, running at boot time without operator intervention.

Whereas the existing systems and apparatuses are specially configured for use, requiring specialized operating systems or particular equipment, the present invention in one embodiment employs off-the-shelf equipment and operability across various operating systems, such as Linux. Indeed, in a preferred embodiment, the software employed is Web 2.0 technology.

Accordingly, it is desirable to provide an improved system, apparatus and methods for imaging to facilitate mission planning and operation.

### SUMMARY OF THE INVENTION

The present invention provides systems, apparatuses and methods for imaging terrain during flight and providing a means for the pilot to achieve a better flight path.

Embodiments of the systems, apparatuses and methodologies in accordance with the present invention further comprise computers and imaging sensors to gather and dynamically compute flight paths, and displays, upon which the underlying terrain and flight path(s) can be displayed, which along with graphical techniques allows the pilot visual clues as to the situation and circumstances being faced.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying DRAWINGS, where like reference numerals designate like structural and other elements, in which:

FIG. 1 illustrates an exemplary prior art static flight plan configuration;

FIG. 2 illustrates a representative system for practicing the principles of the present invention in accordance with a first embodiment thereof;

FIG. 3 illustrates the terrain and flight information shown in FIG. 2;

FIG. 4A illustrates a representative prior art coverage efficiency over three flights;

FIG. 4B illustrates a representative coverage efficiency over three flights in accordance with one embodiment of the present invention;

FIG. 5 illustrates exemplary camera and display equipment in accordance with one embodiment of the present invention; and

FIG. 6 illustrates exemplary camera and deployment equipment using various communications protocols in another embodiment of the present invention.

### DETAILED DESCRIPTION OF THE PRESENT INVENTION

The present invention will now be described more fully hereinafter with reference to the accompanying DRAWINGS, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

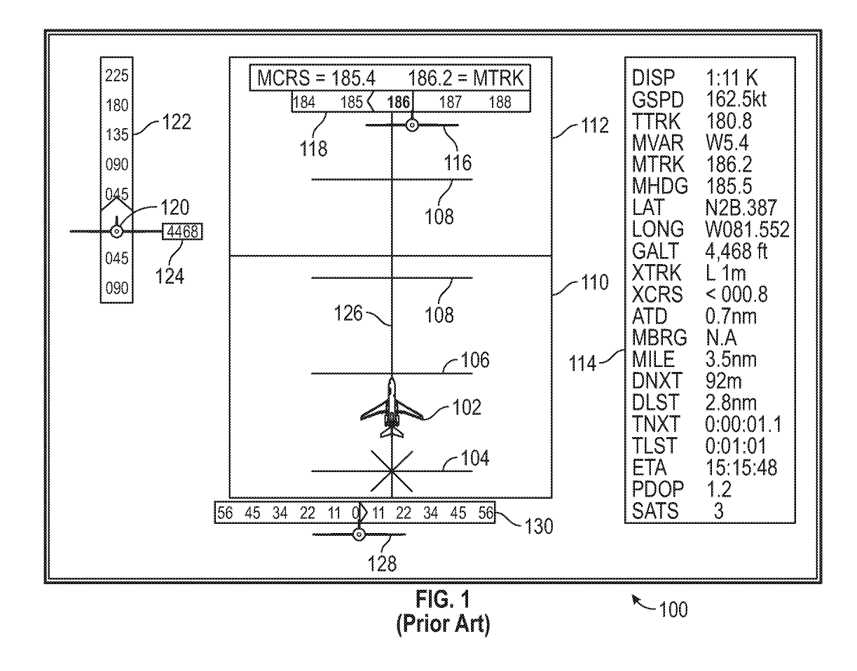

An exemplary prior art commercial pilot's graphics display is shown in FIG. 1 of the DRAWINGS, generally designated by the reference numeral 100. As discussed hereinabove and further hereinbelow, the flight plan and other details are pre-computed and laid in for the pilot with little or no alternate plans permitted or considered. The instant invention is alternatively designed to make the employment of such flight plans and imagery more dynamic, more available to the flight community, and take advantage of the considerable cost-savings in using commonly-known equipment and platforms instead of dedicated use ones.

As shown, the display 100 includes a variety of components used to inform a pilot of the status of the plane and provide situational awareness. The piloted airplane, a representation of which is generally designated by the reference numeral 102, is shown travelling on a flight line path, generally designated by the reference numeral 126, within a situational box 110 on the display 100. Behind the plane 102 is an image marker 104, indicating that this was the position of the last terrain image taken, with the X therethrough indicating that this was in the past. A current image marker, generally designated by the reference numeral 106, illustrates the position of the terrain image being taken now, i.e., as the plane 102 progresses along the flightline 126, the current image is so designated. Upcoming positions for future images are generally designated by the reference numeral 108, one of which is within another box illustrating a representation of the imaging swath taken, generally designated by the reference numeral 112.

Various avionics information, generally designated by the reference numeral 114, are also shown to the pilot, including information on the Display Scale (DISP), where the scale is 1:11,000, Ground Speed (GSPD) in knots, True Track (TTRK), a directional measure in degrees, Magnetic Variation (MTRK), a compass reading, and many other indicators providing critical avionics information about the state of the airplane 102 moving along the pre-planned flightline 126. It should be understood that much more information can be displayed, and that the instrumentation shown in FIG. 1 is merely illustrative.

With reference to FIG. 1, there is another airplane image, generally designated by the reference numeral 116, which is employed, along with a degree measure 118, to visually and simply illustrate the deviation, if any, of the airplane 102 from the desired flightline 126 in degrees, with highlighting and other effects to visually cue the pilot on such deviation. Another measure is the altimeter, where another plane image, generally designated by the reference numeral 120, is shown in relation to an altimeter scale, generally designated by the reference numeral 122, with a precise altimeter reading for the aircraft highlighted, generally designated by the reference numeral 124. Finally, at the bottom, there is another plane representation, generally designated by the reference numeral 128, which is positioned in reference to a scale, generally designated by the reference numeral 130, which visually illustrates the relation of the plane 128 to the flightline 126 and how many meters deviance from that line. In this instance shown, the plane 102 is closely adhering to the pre-configured flightpath 126, although the downrange measure 116 may show some slight deviation.

It should be understood that the above flight information is standard for the pilot's convenience and ease of access. The instant invention provides improvements to this visualization, and, more importantly, tools for providing flexibility in the entire flight path. Instead of being forced to stick to the pre-planned flightline 126, such as illustrated and described in FIG. 1, the improvements of the present invention include capabilities to visualize flight and terrain data more flexibly.

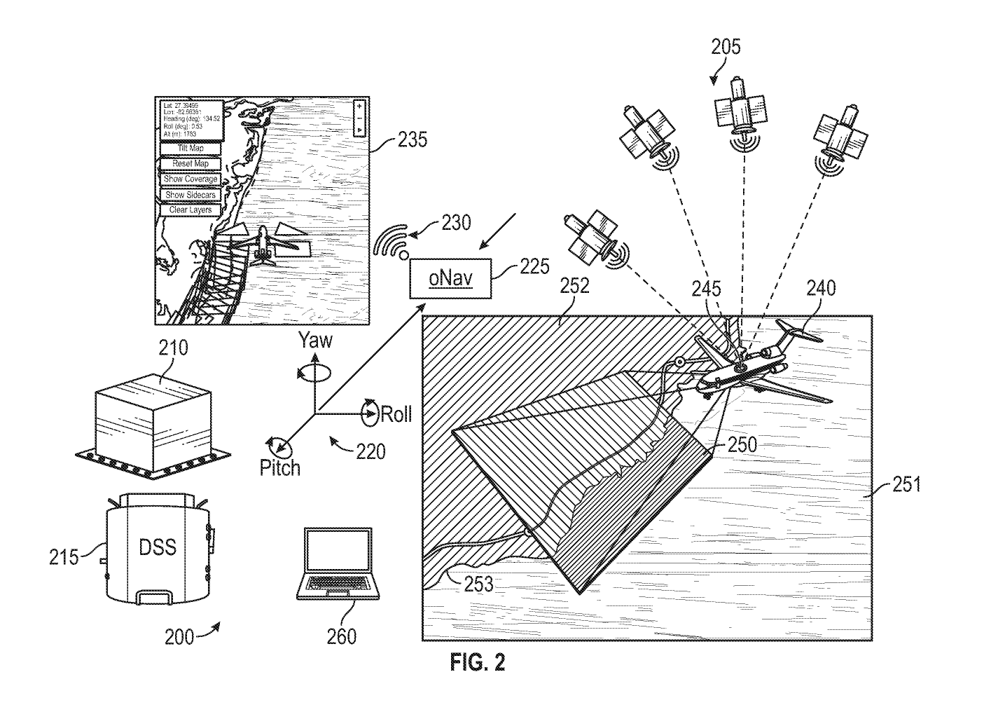

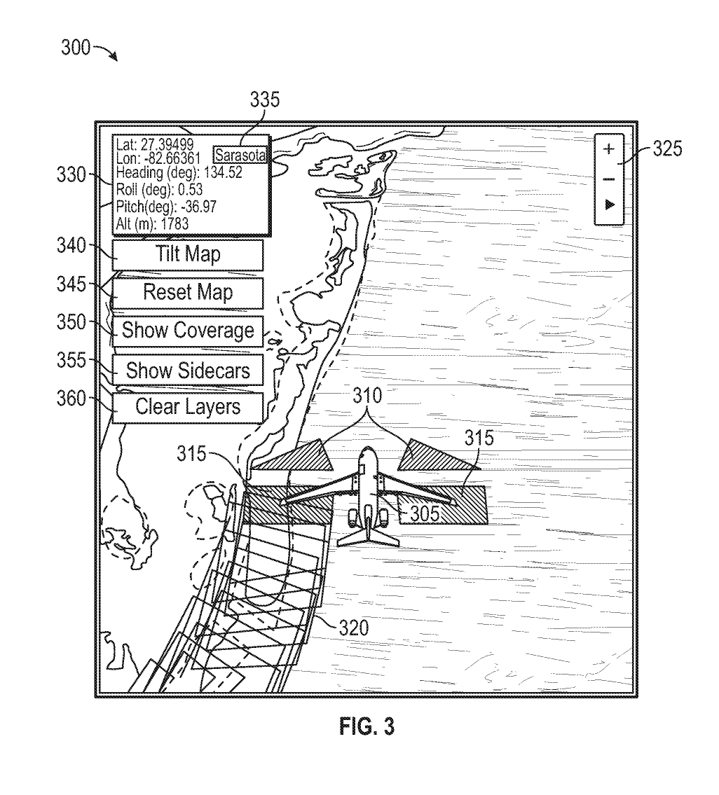

To support oblique imagery acquisition, the present invention preferably employs an open source heads up display for pilot usage. An example of a system of the present invention is generally shown in FIGS. 2 and 3 of the DRAWINGS and generally designated by the reference numerals 200 and 300 therein.

With reference now to FIG. 2 of the DRAWINGS, there is shown a system according to an embodiment of the present invention, generally designated by the reference numeral 200. In a preferred embodiment, the system 200 is built on the Linux operating system (Debian) and utilizes a number of open tools and data such as: GPSD (a GPS daemon), PHP scripting languages, Open Source Software Image Map (OSSIM), MapBox GL JS API, a JavaScript library that uses WebGL for render maps from vector tiles, such as from TileServer, United States Geological Survey (USGS) National Map and Open Street Map.

In a preferred system of the present invention, the system 200 parses geospacial information received from a real-time Global Positioning System (GPS), generally designated by the reference numeral 205, which shows a number of orbiting satellites to enable such positioning, as is understood to those of skill in the art.

Also shown is an Inertial Measurement Unit (IMU), generally designated by the reference numeral 210, which streams, along with image collection metadata from a number of cameras, generally designated by the reference numeral 215, with the data oriented in three-dimensional flight format, such as shown by the graph 220, and sent on to a terrain mapper configuration described herein, generally designated by the reference numeral 225, such as an oNav, described in more detail hereinbelow, which images the terrain, generally designated by the reference numeral 230. The obtained imagery of the terrain beneath the plane is put on a display, generally designated by the reference numeral 235, for the pilot's use on a plane, generally designated by the reference numeral 240, and described in more detail in connection with FIG. 3.

As illustrated, the mapping configuration on the plane 240 receives the terrain information and the other information above through an antennae, generally designated by the reference numeral 245, attached to the plane 240, which coordinates and takes a georeferenced image, e.g., on the underside of the plane 240. The combination of all of this geospacial information and metadata is then used to generate vector overlays that the pilots can use to easily navigate and track progress to ensure full coverage of the survey or georeferenced area, generally designated by the reference numeral 250.

In the visualization of the features in the DRAWINGS, particularly FIG. 2, water or the ocean is depicted using reference numeral 251, land or ground 252, and coastline 253.

As further shown in FIG. 2, the present invention is designed to operate on a variety of computers, such as a laptop or portable computer or device, such as an iPod, tablet, smartphone or other such device, generally designated by the reference numeral 260, to perform the various computations employing the received data, coordinates, maps, metadata, etc., and display the results of the present invention on a display, such as display 235 or another display for ease of pilot use. The image on the display 235 is further illustrated in FIG. 3.

With reference now to FIG. 3 of the DRAWINGS, the improved, dynamic and flexible imaging of the terrain over the prior art is better illustrated. On the display 300, the representation of the plane, generally designated by the reference numeral 305, is shown traversing a flight path along a coastline, which by its nature varies. Existing systems, as described, being pre-planned and pre-configured, have great difficulty if they go off plan and are presented with terrain such as a coastline. The instant invention provides techniques for handling such terrain flexibly. Additionally, the technology of the instant invention gives the pilots flexibility in other measures. For example, if the aircrew arrives at a survey area and finds clouds, they can drop altitude, at which point the map scales appropriately, and they can continue mapping. With the prior art techniques, however, which are altitude dependent, the flight crews would have to fly in circles, while the pilot or an operator in the back generated new flight lines. The instant invention being dynamic and flexible avoids this recurring problem in current systems.

To aid the pilot, an operator or another on the plane, positioning configurations are overlaid on the display 300. For example, left and right upcoming image acquisition areas or polygons are portrayed, generally designated by the reference numeral 310, i.e., where the image will be taken next. In image 300, only the left polygon of the acquisition area 310 is used since that is the terrain requiring mapping. The right polygon or portion is open water, but could also be undifferentiated land. It should, of course, be understood that in alternate embodiments of the present invention, both the left and right areas 310 will be imaged either simultaneously or substantially simultaneously.

Also shown are left and right immediate imaging areas, generally designated by the reference numeral 315, which is where the image is being taken now. Again, only the left image of the coastline is preferably taken. As the images taken accrue, they stack up onto each other, preferably overlapping some terrain for additional accuracy. In depicting this stacking of images, i.e., the image footprints, generally designated by the reference numeral 320, the images are shown as polygons or tiles substantially overlapping each other. Also, the pilot or operator can adjust the scale of resolution through an adjusting menu, generally designated by the reference numeral 325, enhancing the image where needed or scaling back for a broader view. It should also be understood that the menu 325 can also provide different vantage points, e.g., directional indications and other positionings.

With further reference to FIG. 3, the present invention provides a variety of information to the pilot. At the top left of the display 300 there is a base map, generally designated by a box with the reference numeral 330, which includes much of the critical situational awareness data needed, such as direction, heading, altitude, etc., much of which was described in connection with FIG. 1. In a preferred embodiment of the present invention, the box 330 is substantially transparent, enabling the underlying terrain to be visible therethrough, providing more detail to the pilot. Also, a geographic indicator, generally designated by the reference numeral 335, may be included within or adjacent the base map 330 to specify the precise area being traversed.

The display 300 also includes various controls to enable the pilot to obtain more detail should they need it or modify or remove details. For example, a so-called Tilt Map, generally designated by the reference numeral 340, provides information on the three-dimensional spatial orientation of the image, e.g., is the plane 305 and the imaging pitched down, rolling, yawing, etc., as described and illustrated in connection with the coordinate system 220 shown in FIG. 2. To eliminate such tilting, and align the pilot viewpoint, a Reset Map button or selection, generally designated by the reference numeral 345, resets the system and aligns the view on the monitor or display to straight down.

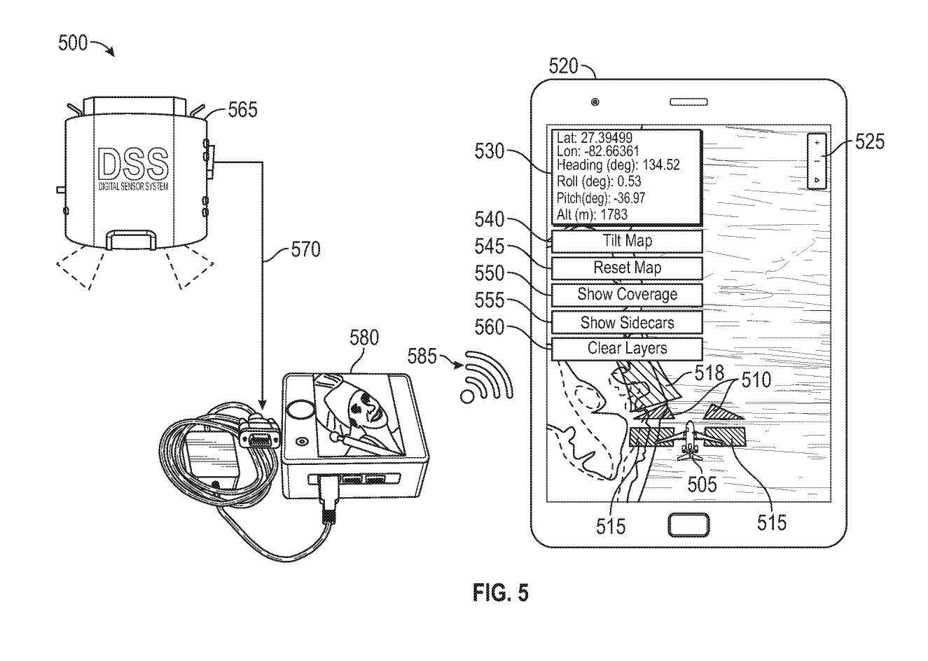

As mentioned, the present invention allows the usage of the information and also permits the selective portrayal of the information. For example, a Show Coverage selection, generally designated by the reference numeral 350, enables the illustration of the aforementioned stack of images or footprints 320, or allows this information to not be depicted. Similarly, a Show Sidecars selection, generally designated by the reference numeral 355, will upload designated areas of interest and map them onto the terrain, which is shown and described in more detail in connection with FIG. 5. Finally, a Clear Layers selection, generally designated by the reference numeral 360, will, as indicated, clear out the footprints 320 and any areas of interest or sidecars 355.

It should be understood that the Tilt Map 340, Reset Map 345, Show Coverage 350, Show Sidecars 355 and Clear Layers 360 can be selected and deployed in various ways, e.g., via a computer mouse, a touch screen or other means, as is understood in the art. In this manner, the various commands can be interactive and the display easily and quickly modified to suit the preference of the viewer or viewers.

In a preferred embodiment of the instant invention various colors are employed to better illustrate and contrast the features of the present invention, thereby better enabling instant pilot visualization and understanding. For example, in depicting the footprints 320, the various overlaying terrain snapshots or polygons can be in a translucent blue, i.e., the terrain underneath is visible

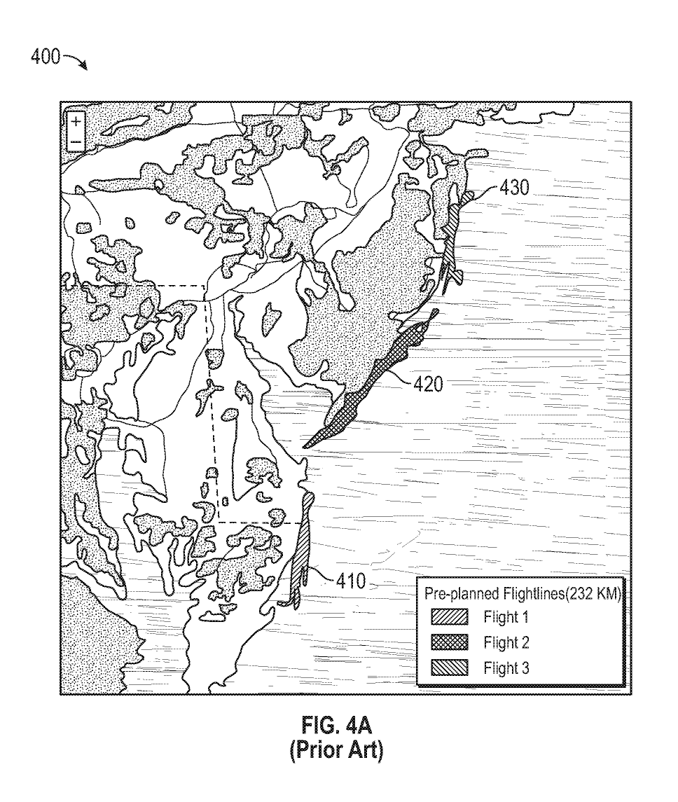

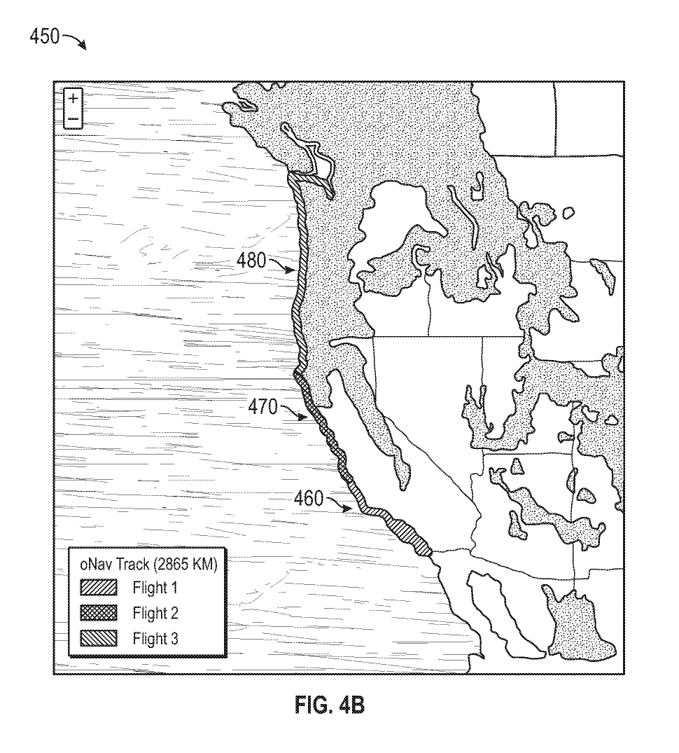

With reference now to FIG. 4 of the DRAWINGS, there are shown an approach according to the prior art, as shown in FIG. 4A, and an improved approach according to the present invention, as shown in FIG. 4B.

As shown by the comparison between FIG. 4A and FIG. 4B of the DRAWINGS, the strategy of the present invention has vastly improved the efficiency with which imagery can be collected. For example, in FIG. 4A there is shown a coverage efficiency chart, generally designated by the reference numeral 400, that gathered data for three flights, generally designated by the reference numerals 410, 420 and 430, respectively, over a regional coastline area using existing techniques. As shown, the coverage is quite choppy, forming uneven and thick structures in the figure, especially when compared to the efficiency coverage of another area employing the principles of the present invention, as generally illustrated in FIG. 4B, which is considerably more even and much thinner.

The coverage efficiency chart shown in FIG. 4B, generally designated by the reference numeral 450, illustrates three flight paths, generally designated by the reference numerals 460, 470 and 480, respectively, over another coastline area using the techniques of the present invention, which are quite better than those of the existing techniques shown in FIG. 4A. Also, the scale of the imaging is quite different. For example, whereas the prior art technique in FIG. 4A is capable of imaging a regional area in the small hundreds of miles, in this example approximately 232 kilometers of Maryland, Delaware and New Jersey, the scale of the technique employed in the instant invention is not only more accurate but in the thousands of miles, here approximately 2,565 kilometers of the entire Western coastline of the United States. Indeed, the oblique navigation techniques of the present invention are a marked improvement over all existing techniques.

With reference now to FIG. 5 of the DRAWINGS, there are shown exemplary components that may be employed in practicing the principles of the present invention, generally designated by the reference numeral 500, and displaying the improved flight path data on a laptop, PDS or other display, generally designated by the reference numerals 520. As shown, imaging data, such as acquired by a sensor system or camera, generally designated by the reference numeral 565, is acquired, and transmitted, via a transmission means, generally designated by the reference numeral 570, to a portable device, generally designated by the reference numeral 580. It should be understood that the transmission means 570 can be either through wireline or wireless transmission, e.g., serial to USB, as illustrated, or wirelessly. The data transmission standard preferably employs one by the National Marine Electronics Association, a specification that defines the interface between various pieces of marine electronic equipment. The NMEA standard permits marine electronics to send information to computers and to other marine equipment, as is understood in the art. The device 580 receiving the data can then transmit the imaging data, e.g., wirelessly 585, to the display device 520 for pilot use.

As with FIG. 3, the display 520 of the portable device illustrates various improvements of the present invention. As described in more detail in FIG. 3, a representational plane, generally designated by the reference numeral 505, has upcoming data acquisition targets, generally designated by the reference numeral 510, and current imaging acquisition areas, generally designated by the reference numeral 515. As discussed, areas of interest or so-called sidecars can also be portrayed, generally designated by the reference numeral 518, which overlays the terrain imaged, providing the pilot and others visual clues as to these areas of interest coming up near the flight path being taken. Also, the aforementioned stacks of images or footprints are not shown in this Figure, e.g., the show sidecar option 355 is activated and the show coverage 350 is deactivated in FIG. 5, e.g., when the pilot is just looking for some area of interest. As with FIG. 3, a base map 530, tilt map 540, reset map 545, show coverage 550, show sidecars 555 and clear layers 560 are also available in this configuration.

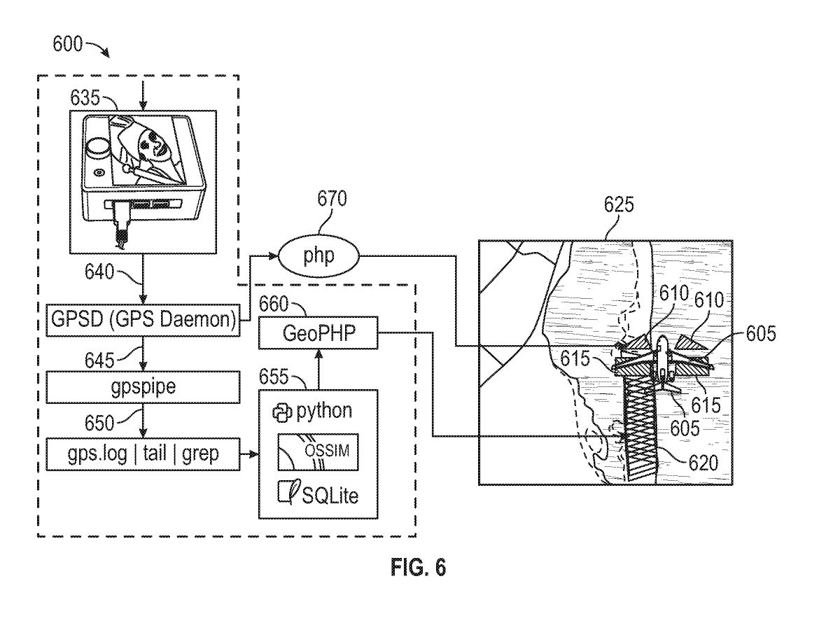

Finally, another preferred embodiment and configuration of the present invention is shown in FIG. 6 of the DRAWINGS, generally designated by the reference numeral 600.

Another preferred embodiment for practicing the present invention involves oNav, an exemplary hardware setup, which includes a Linux computer with: PHP, Python, GPSD, Sqlite, Apache webserver, hostapd configured to act as a wireless access point, Tileserver (to display offline raster or vector base maps), Open Source Software Image Map (OSSIM) to calculate image location data, Mapbox GL JS, and raster/vector/elevation base maps for the project area or the world.

As noted hereinabove, a flexible flight path is depicted on a display, generally designated by the reference numeral 625, with the terrain being flexibly mapped, as described. Indeed, no flightline or designated path is depicted. A further representational plane, which is generally designated herein by the reference numeral 605, has upcoming data acquisition targets, which are generally designated by the reference numeral 610, and current imaging acquisition areas, generally designated by the reference numeral 615. Also shown are the aforementioned stacks of images or footprints, generally designated by the reference numeral 620, which in this embodiment slightly overlay the right portion of the current imaging targets 615.

A preferred data acquisition mechanism is shown in this embodiment, employing some of the above-named technologies and standards, along with some others. As shown in FIG. 6, data from a sensor apparatus or camera, such as camera 215, gathers data, e.g., pursuant to the aforementioned NMEA standard, is forwarded to a portable device, generally designated by the reference numeral 635. As shown, the data preferably transits through a GPSD, generally designated by the reference numeral 640, through a gpspipe, generally designated by the reference numeral 645, and through a gps.log and command grep, generally designated by the reference numeral 650. The data is then passed through a python configuration, generally designated by the reference numeral 655, which includes OSSIM and SQlite, as described hereinabove. Finally, the data passes through a GeoPHP, which is an open-source native Hypertext Preprogramming language (PHP) library for doing geometry operations. As is understood in the art, GeoPHP is written entirely in PHP and can therefore run on shared hosts, and can read and write a wide variety of formats (WKT, WKB, GeoJSON, KML, GPX, GeoRSS). GeoPHP works with all Simple-Feature geometries (Point, LineString, Polygon, GeometryCollection etc.) and can be used to get centroids, bounding-boxes, area, and a wide variety of other useful information. As shown in FIG. 7, all of the collected data, spatial coordinates and other information are employed in the rendering of the stacked images taken or footprint 620.

With further reference to FIG. 6, the data, information and metadata also passes through the GPSD and through a regular php, which is employed in the calculation of the next areas 610 for data imaging, as is understood in the art.

It should be understood that the various data can be displayed in different ways. An illustrative example of a preferred manner of displaying involves displaying both the images of the area and the generated flight path information in separate windows.

In one preferred embodiment for practicing the present invention or oNav, an exemplary hardware setup includes a Linux computer with: PHP, Python, GPSD, Sqlite, Apache webserver, hostapd configured to act as a wireless access point, Tileserver (to display offline raster or vector base maps), Open Source Software Image Map (OSSIM) to calculate image location data, Mapbox GL JS, and raster/vector/elevation base maps for the project area or the world.

It should be understood that various commands employed in practicing the present invention may be implemented in various ways. For example, in another embodiment of the present invention, oNav is a set of scripts that run as a daemon on the Linux operating system. When the user applies power to the system, a bash shell script starts the primary processing Python script such that it will auto start if a failure occurs in the Python script. This Python script instructs GPSDaemon (open source daemon for reading GPS data streams that also starts at boot time) to begin logging the GPS/IMU/camera data stream from the camera unit. The camera unit is preferably configured to stream the correct messages for each image. On an interval, the Python script parses the GPSD log to determine if the camera(s) has fired. If there is a camera event, the position and orientation data for the image(s) are prepared for OSSIM. OSSIM calculates the image footprint based on the image dimensions, calibration information and location relative to an elevation model. This information is then preferably entered into a Sqlite database that is created at boot time.

It should be understood that in at least one preferred embodiment of the present invention, the techniques are based entirely on open source software and libraries.

It should also be understood that preferred embodiments of the present invention are self-starting, and run at boot time without operator intervention.

It should further be understood that preferred embodiments of the present invention employ Web 2.0 or like functionality. In particular, the present invention should be browser based and platform agnostic. Also, the present invention should be scalable, even massively scalable and deployable over many geographical areas, particularly anywhere in Contiguous United States (CONUS), Alaska and Puerto Rico for U.S.-based systems. It should, of course, be understood that the principles set forth herein can also be deployable across any geographical area in the world. Also, the preferred embodiments include the hybrid delivery of offline raster and vector tiles.

It should additionally be understood that the instant invention and all preferred embodiments thereof not being based on pre-determined flight lines, allow free form navigation, on-the-fly mission planning, and, due to the cost savings inherent in the configuration of the present invention, up to a tenfold decrease in cost as compared to the utilization of pre-determined flight lines.

It should further be understood that preferred embodiments of the present invention also provide real-time flight coverage employing standard open-source web services, both on the operator laptop and the pilot display.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the breadth or scope of the applicant's concept. Furthermore, although the present invention has been described in connection with a number of exemplary embodiments and implementations, the present invention is not so limited but rather covers various modifications and equivalent arrangements, which fall within the purview of the appended claims.

We claim:

1. A navigation system for use on an airplane comprising:
at least one sensor, said at least one sensor receiving data and at least one image of a geographical feature underneath said airplane;
at least one processor, said at least one processor receiving said data and said at least one image from said at least one sensor, and generating therefrom at least one polygon and superimposing said at least one polygon on said at least one image;
a display, said display receiving said data and said at least one image of said geographical feature with said at least one polygon superimposed thereon, and displaying same,
wherein said at least one polygon is superimposed along a current flight path of said airplane, and
wherein said at least one polygon and said current flight path are dynamically computed and not pre-computed.

2. The navigation system according to claim 1, wherein said at least one polygon constitutes a position for an upcoming georeferenced image along said current flight path over said geographical feature,
wherein, when said airplane reaches said position, at least image of said geographical feature is obtained.

3. The navigation system according to claim 1, wherein said at least one polygon constitutes a representation of a portion of said geographical feature under said airplane.

4. The navigation system according to claim 1, wherein said at least one polygon comprises at least two polygons.

5. The navigation system according to claim 4, wherein said at least two polygons constitute representations of portions of said geographical feature at the left and at the right of said flight path.

6. The navigation system according to claim 1, further comprising:
a memory, said memory containing a plurality of said at least one images of said geographical feature taken along said flight path,
wherein at least two of said plurality of said at least one images of said geographical feature taken along said flight path overlap.

7. The navigation system according to claim 6, wherein a plurality of said plurality of said at least one images of said geographical feature taken along said flight path overlap.

8. The navigation system according to claim 1, wherein said at least one sensor comprises a camera.

9. The navigation system according to claim 1, wherein said navigational system employs open source technology.

10. The navigation system according to claim 9, wherein said open source technology comprises a Linux Operating System.

11. The navigation system according to claim 1, further comprising:
an antennae, said antennae configured to receive data, metadata and GPS information pertaining to said airplane and forward same to said at least one processor.

12. The navigation system according to claim 1, further comprising:
a portable device, said portable device receiving said data and said at least one image of a geographical feature underneath said airplane from said at least one sensor, and forwarding said data and said at least one image of a geographical feature to said at least one processor.

13. The navigation system according to claim 1, wherein said display has a selection section, said selection section including a command selected from the group consisting of tilt map, reset map, show coverage, show areas of interest, clear layers, and combinations thereof.

14. The navigation system according to claim 13, wherein said selection section is on a touch screen.

15. A navigation method for an airplane comprising:
receiving, at a processor, data and at least one image of a geographical feature being overflown by said airplane from said at least one sensor;
generating at least one polygon and superimposing said at least one polygon on said at least one image; and
displaying said data and said at least one image of said geographical feature with said at least one polygon superimposed thereon,
wherein said at least one polygon is superimposed along a current flight path of said airplane, and
wherein said at least one polygon and said current flight path are dynamically computed and not pre-computed.
